(19) United States
(12) Patent Application Publication
(10) Pub. No.: US 2006/0206437 A1
(43) Pub. Date: Sep. 14, 2006

(54) Financial transaction processing system

(75) Inventors: John A. Jones, Suwanee, GA (US); Harold Bray, Seminole, FL (US); James H. Smith, Danville, CA (US); Jeffrey A. Wakefield, Uxbridge, MA (US); Gregory M Sokolowski, Shrewsbury, MA (US); Frank J. Decaro, Worcester, MA (US); Paul J. Vermeulen, Tampa, FL (US); Kumar S. Choudhuri, Marietta, GA (US); David M. Janes, Marietta, GA (US); Charles C. Brown, Lutz, FL (US); Tom G. Golba, Livermore, CA (US); Thomas C. Ammon, Mountain View, CA (US); Karl Chrisman, Livermore, CA (US)

Correspondence Address: NIXON & VANDERHYE, PC, 901 NORTH GLEBE ROAD, 11TH FLOOR, ARLINGTON, VA, 22203, US

(73) Assignee: IVI Checkmate Corp., Roswell, GA (US)

(21) Appl. No.: 11/433,693

(22) Filed: May 15, 2006

Related U.S. Application Data
(62) Division of application No. 09/863,759, filed on May 24, 2001.
(60) Provisional application No. 60/288,426, filed on May 4, 2001.

(51) Int. Cl. G06Q 99/00

(52) U.S. Cl. 705/72

(57) ABSTRACT

An automated method provides an efficient arrangement for setting certain financial transactions using a debit point of sale transaction network, as opposed to routing over a credit network. The method and arrangement uses an onsite database of bank identification numbers to conduct a preliminary assessment of whether a particular card is debit capable, and appropriately processes the transaction information based on the preliminary assessment. The system preferably is also updated when a financial transaction is successfully completed as a debit transaction which the database did not initially identify as being debit capable. In this way, the database is continuously updated and over time, a more accurate database is achieved. The system can also be networked, such that information between databases is shard and improved, based on the network experience.

### CROSS-REFERENCE TO RELATED APPLICATIONS

This application is a divisional of U.S. patent application Ser. No. 09/863,759 filed May 24, 2004 (now allowed) which was based on and claims priority from U.S. Provisional Patent Application Ser. No. 60/288,426 filed May 4, 2001.

### TECHNICAL FIELD

Systems and methods are provided for processing financial transactions where payment is being made by acceptance of a financial transaction card. In particular, a method and system is provided for processing these transactions in a timely, efficient, and cost effective manner for the merchant.

### BACKGROUND

Financial transaction systems have undergone numerous changes due to the technology that allows real time communication and effective settlement of financial transactions electronically. Many of these transactions are still based on credit cards where the user of the card has obtained a financial line of credit from a particular card provider such as VISA, MASTERCARD, AMERICAN EXPRESS or DISCOVER. The presentation of the card to complete a financial transaction typically requires reading a magnetic stripe code provided on the card, and sending this information together with the financial transaction information through a credit protocol system to confirm that the card holder has sufficient credit available to complete the transaction. The card holder then completes the transaction by signing a receipt.

More recently, debit cards have been introduced which require funds on deposit to complete the approval of the purchase. As with charge cards, electronic card readers obtain information from the card, combine this with the financial transaction information, and forward this combined information to the issuing card source, typically a bank. The bank then confirms that sufficient funds are available with respect to that particular account and approves the transaction.

The financial transaction industry has an extensive system for processing transactions. These systems effectively route the electronic message associated with a transaction to the correct source and provide an approval signal back to the merchant. The merchant or store pays a contracted transaction cost for processing of the transaction and these transaction costs often include a flat fee per transaction plus a percentage cost of the value of the transaction. These costs are typically negotiated and the cost per transaction can be lower where there is substantial volume. With respect to credit cards, VISA and MASTERCARD dominate the market and are in a strong negotiating position. In many cases, the cost per transaction is in the order of 5 cents to ten cents or higher, and the additional percentage cost per transaction can be up to about 2 and one half percent.

For low dollar purchases, these costs are not that significant, however, for higher priced purchases, the percentage cost becomes a significant amount. With credit purchases, there is some risk associated with receiving payment and other costs associated with stolen cards, etc. but for large stores which typically have high value purchases, these transaction or settlement costs are difficult to justify.

Debit cards, commonly referred to as check cards, require funds to be available on deposit and traditionally have been closely tied to the banking institutions. A different protocol and alternative transaction network is available for processing of these debit transactions. The alternative network is commonly referred to as the “Debit POS Network”. The costs associated with processing a debit transaction, are significantly lower and sometimes are based on a negotiated flat charge fee. The flat charge fee can be in the order of 20 to 30 cents per transaction. Therefore, if the financial transaction is a debit transaction where the customer enters a personal identification number (PIN) to effect authorization, the transaction is preferrably communicated to a financial institute such as a bank over the Debit POS network, and the merchant's costs associated with that transaction are relatively low. In contrast, a credit transaction is processed over a credit network and has a different cost associated therewith which is paid for by the merchant.

There are also certain debit cards which carry a credit card logo such as VISA or MASTERCARD or others, which require funds on deposit as the basis for approval of the purchase. These cards also have the capability of allowing the user to approve the purchase based on a signature or based on the entry of a PIN. If the user enters a PIN, the transaction is capable of being processed over the debit network, whereas, if the customer completes approval based on a signature, the transaction is communicated over the credit network. Basically, debit transactions, whether signature based or PIN based, can be communicated over the credit network, however, the merchant is then charged a fee arrangement which is usually higher than the fees for using the Debit POS Network.

From the above, it can be appreciated that in most cases, it is in the merchant's interest, when possible, to have transactions completed as PIN-based debit transactions and have the transactions sent through the Debit POS Network to the financial institute for approval. This typically results in lower costs to the merchant and does not result in any additional costs to the customer. From the customer's standpoint, it is really immaterial whether his debit transaction is communicated through the credit network or the debit network. He is unaware of these costs and there is no additional cost to him.

It is financially rewarding for the credit card companies to have as much traffic directed through their network as possible. They prefer to have debit transactions which are PIN-based communicated through the credit network. In some cases, the costs of a PIN-based debit transaction communicated through the credit network, is less than the lowest cost credit transaction. In this way, the merchant is realizing lower transaction fees for PIN-based debit transactions. These reduced costs are often considerably higher than the costs associated with processing the same transaction through the debit network.

A further problem occurs in that it is sometimes difficult to identify cards which are capable of being processed through the debit network. There is certain information associated with credit and debit cards which allows at least partial identification of the type of card. The card typically has a “primary account number” associated therewith. A portion of this primary account number can be compared to industry available BIN tables (bank identification number). The result of this comparison can provide information whether the transaction can be routed via the Debit POS Network. These BIN tables do not necessarily identify all cards which are debit capable.

From the above, it can be appreciated that for the merchant, it would be desirable to have a system where transactions which are capable of being settled as a debit transaction are communicated over the debit network to reduce his transaction costs. The present invention provides a method and system to alleviate some of the problems described above.

### SUMMARY

An automated method of card acceptance for processing financial transactions using a debit or credit protocol comprises the steps of using an in store terminal to machine read a financial transaction card and obtain a primary account number associated therewith, providing the primary account number to a database of card information and comparing the primary account number with the database to provide a preliminary assessment categorizing the card as 1) known to be debit capable 2) unknown to be debit capable or 3) known to be only credit capable, processing known only credit capable cards using a credit protocol, processing known debit capable cards using a modified debit protocol that initially assumes a PIN authorization debit protocol and prompts a card holder to enter the PIN authorization, said modified debit protocol defaulting to a different authorization protocol or credit protocol when a request to override is received and thereafter following the protocol according to the request to override, and processing unknown to be debit capable cards using a protocol that initially requires a clarification signal selecting a debit or credit protocol, and thereafter processing the transaction using the selected protocol.

According to an aspect of the invention, the debit protocol associated with an unknown to be debit capable card is said modified debit protocol.

According to a further aspect of the invention, the automated method includes the step of tracking clarification indicating a debit transaction and recording of the primary account number associated therewith to update the database whereby future transactions using the transaction card will be categorized as a debit capable card.

In a further aspect of the invention, the step of comparing the primary account number with the database occurs at a store where said instore terminal is located.

In yet a further aspect of the invention, the step of comparing the primary account number is completed within a few seconds of the machine reading the primary account number.

In yet a further aspect of the invention, the automated method includes the step of defaulting to the protocol of an unknown to-be debit capable card, if the step of assessing the card is not completed within a specified time.

In yet a further aspect of the invention, the automated method includes watching each transaction of an unknown to be debit capable card for successful completion, based on a debit protocol, and taking steps to update the database such that future transactions using the respective card will be processed as a known to be debit capable card.

An arrangement for identifying and processing transactions that may be capable of being settled using a debit protocol according to the invention comprises an onsite store computer system connected through an outside network to a financial transaction network. The store computer system includes a series of terminals for the electronic payment of purchases, an onsite database computer in communication with each terminal. Each terminal includes a device for receiving a financial transaction card and determining a primary account number associated therewith, means for communicating the primary account number to the onsite database computer. The onsite database computer upon receiving the primary account number from any of the terminals evaluates the primary account and provides a report to the respective terminal, whether the primary account number is recognized by the onsite database computer as debit transaction capable. Each terminal upon receipt of a report indicating the primary account number is known to be debit transaction capable, produces a prompt for the card holder to enter an authorization and upon receipt of a PIN, processes the transaction using a PIN based debit protocol. The terminal upon receipt of a signal indicating PIN authorization, will not be completed unless the card holder provides other alternatives for completing authorization of the transaction.

In a preferred aspect of the invention, the arrangement upon successful completion of a financial transaction using a debit protocol of a particular financial transaction card which was not initially recognized by the database computer, the system updates the database such that future transactions will recognize the particular primary account number as debit capable. In this way, the arrangement basically watches for successful completion of debit transactions and if the database did not provide an initial indication that this was possible, updates the database such that future transactions are identified as being capable of being settled on this basis. Thus the arrangement effectively watches the transactions and improves the database based on successful completion of transactions.

Basically, the arrangement encourages customers to settle a debit transaction capable card based on a PIN authorization and the merchant can then arrange for these types of transactions to be settled in a cost effective manner using the Debit POS Network. In contrast, recognized credit transactions are processed in the normal manner and at the higher cost.

The present invention also provides an arrangement that identifies and processes transactions that are capable of being settled, using a debit protocol. The system comprises a plurality of onsite store computer systems which can communicate through an outside network to a remote computer system. Each store computer system includes a series of terminals for the electronic payment of purchases and the terminals cooperate with an onsite database computer. Each terminal includes a device for receiving a financial transaction card and determining a primary account number associated therewith, means for communicating the primary account number to the onsite database computer. The onsite database computer upon receiving a primary account number from any of the terminals, evaluates the primary account number and provides a report to the respective terminal whether the primary account number is recognized by the onsite database computer as debit transaction capable. Each terminal upon receipt of a signal indicating debit transaction capable, produces a prompt for the card holder to enter a PIN authorization and upon receipt of a PIN, processes the transaction using a debit protocol. The terminal upon an indication PIN authorization will not be completed by the card holder, provides other alternatives for completing authorization of the transaction.

### BRIEF DESCRIPTION OF THE DRAWINGS

Preferred embodiments of the invention are shown in the drawings, wherein:

FIG. 1 shows a series of entries in a BIN table;

FIG. 2 shows the entries of FIG. 1 reformatted for easier recognition;

FIG. 3 shows a BIN table in a preferred manner;

FIG. 4 is a schematic of a single multi lane retail outlet; and

FIG. 5 shows an arrangement for use with a series of retail outlets.

### DETAILED DESCRIPTION OF EXEMPLARY EMBODIMENTS

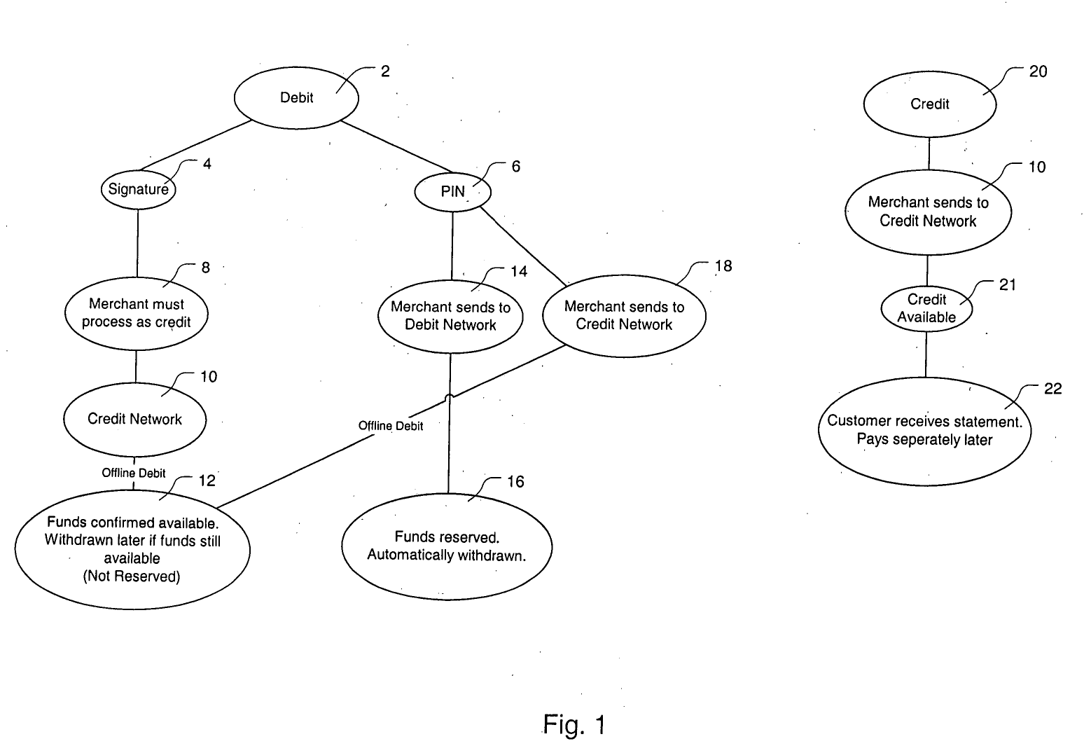

FIG. 1 shows a simplified flowchart of the steps and alternatives for processing transactions using a debit or credit protocol. A recognized debit transaction 2, depending upon the issuing institute, can be authorized based on a signature authorization 4 or a PIN authorization 6. If it is a signature authorization, the merchant at 8 must process the transaction as a credit transaction and forwards the card information and the transaction information to the credit network identified as 10. This transaction is sometimes referred to as an off line debit transaction in that the financial institute at 12 confirms that funds are available and these funds are withdrawn later if the funds still remain available. For example, the particular account is checked to confirm that there are sufficient funds to pay for the transaction and effectively, the transaction is completed as far as the merchant is concerned. The merchant will eventually receive a settlement report where the amount of the financial transaction, less the settlement fee, are credited to the merchant. Although the funds are confirmed as being available at 12, the funds are typically not removed from the account nor reserved for a certain time period, typically from 24 to 48 hours later.

If a PIN is entered at 6, the merchant at 14 sends the card information and the financial transaction information to the debit network 14. The issuing financial institute, at 16, determines whether the funds are available, and if so, automatically reserves the funds for withdrawal. This withdrawal may occur right away, or typically at the end of the day. The funds are reserved and thus the financial transaction is essentially completed.

As described in the background of the invention, the costs to the merchant to settle this debit transaction are less, particularly if this is a high dollar value purchase. In some circumstances, even though the PIN authorization has been entered at 6, the merchant has contracted with the credit network to receive PIN authorized debit and will be charged a certain settlement fee. In this case, the card information and financial transaction information is sent by the merchant at 18 to the credit network and this is typically settled as an off line debit and funds are confirmed available and withdrawn later as shown at 12.

Typically, for the merchant, if the PIN is entered at 6, it is the most cost effective to process the transaction by sending it to the debit network, at 14, and have the funds reserved as shown at 16. Off line debit based on the signature 4 or off line debit due to the merchant contracting with the credit network at 18, are typically higher cost settlement transactions.

FIG. 1 also shows how the credit transaction 20 is sent by the merchant to the credit network 10 and the customer at 22 receives a statement typically at month end or some other period, and pays for it separately. The credit network 10 confirms at 21 that credit is available.

The credit network 10 is capable of processing both credit transactions and debit transactions whether these debit transactions are signature based or PIN based. The debit network 14 at the present point in time requires PIN authorization and only PIN authorized debit transactions can be processed in the cost effective manner over the debit network. The funds of the card holder are treated somewhat differently but to the customer, the difference in treatment of the funds at 12 and 16 are probably unknown and insignificant.

The credit network 10 is very aggressive and has well known ties with the various merchants, card issuers and processors. The introduction of debit transactions and the more cost effective processing of such debit transactions was partially offset by the credit network noting that they would also process debit transactions as their modified transaction called off line debit. This transaction is marketed as being a cost effective settlement process for the merchant, however, it is not nearly as cost effective as a PIN based debit transaction sent through the Debit POS Network.

To further compound the problem, it is not always possible to recognize a financial transaction card as being debit capable, merely by the account number or information provided on the card. Certain debit cards carry the name of credit Networks such as VISA and MASTERCARD. The bank identification numbers reserved for VISA and MASTERCARD, are large blocks of numbers and these numbers can include both pure charge cards which must be processed over the credit network 10 and also debit cards which can include PIN authorization and signature authorization transactions. Therefore, there is not necessarily a clean distinction based on BIN tables, whether a card is debit capable. Furthermore, it can be appreciated that certain debit cards can have a signature authorization and the customer may prefer this approach. The BIN tables can provide a determination that a particular card is debit capable but these BIN tables typically do not identify all cards which are debit capable.

For the merchant, it is more cost effective to have most, if not all of the debit capable cards, settled, based on a PIN authorization which is forwarded to the debit network. To the card holder, it is normally immaterial how the transaction is settled, as the treatment of his funds on deposit is generally the same.

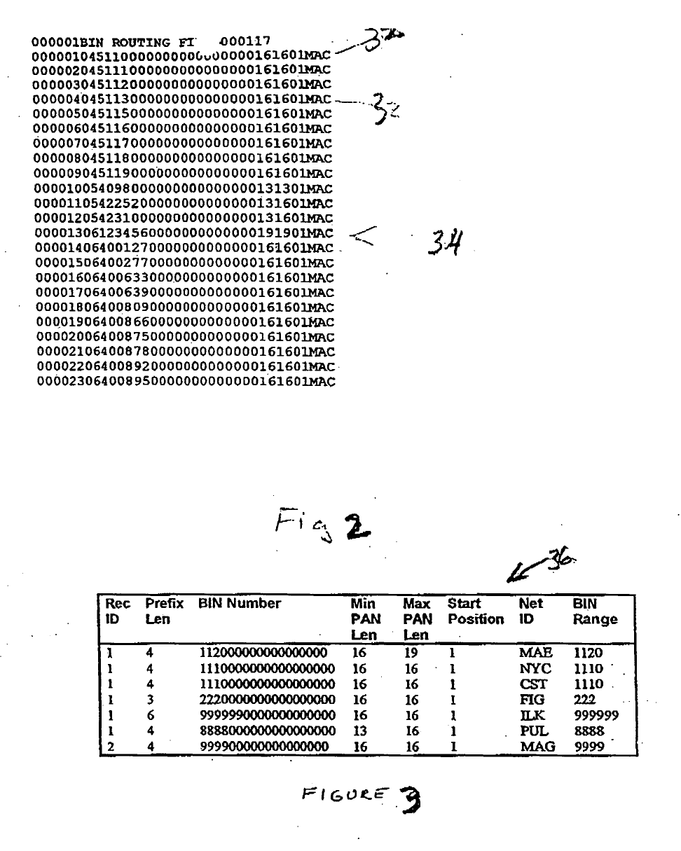

To assist the merchant in making informed decisions with respect to how transactions are processed, a table of BIN numbers are provided in the computer database at the store site. A series of BIN numbers are shown in FIG. 2 where the table 34 has a host of BIN numbers 32. Each line of the table 34 corresponds to information associated with a particular card or group of cards and provides information with respect to the processing of transactions associated with the particular cards.

FIG. 3 shows a similar BIN table 36 which has been divided for easier understanding with certain titles over the various columns. Unfortunately, the format of BIN tables varies between financial institutes and is not standard. It is in the interest of any institute associated with the credit network to have the transactions processed using the credit network. The parties associated with the credit network are often also associated with the debit network. It is generally in their interest to promote transactions through the credit network, however, they recognize the need for and the lower costs of the debit network.

In contrast, it is in the merchant's interest to direct traffic through the debit network if possible. This benefit to the merchant is significant but the merchant must also be aware that the customer should not be dissatisfied with the process. The system as will be subsequently described, basically conducts a preliminary evaluation whether the information from the financial transaction card allows the determination whether it is debit capable and if so, prompts the customer to complete a PIN based debit transaction. This process also recognizes that the customer may not wish to complete the transaction using a debit protocol and the process allows the customer to complete the transaction using other alternatives. This pre-evaluation must occur quickly to avoid delays in check-out lines and to avoid customer frustration. Often the card is initially swiped and the pre-evaluation step is carried out before the financial transaction is complete.

The present system allows the onsite database containing BIN numbers to conduct an initial pre-evaluation to determine cards which are debit capable and to identify cards which are only credit capable. Credit capable cards are only processed according to a credit protocol whereas the debit capable cards are processed to promote PIN based debit transactions. The system recognizes that the BIN tables are not as complete as desired in that certain debit capable cards are not recognized by the database. The system provides a watching feature for transactions that were successfully completed based on a debit protocol where the initial pre evaluation was not able to distinguish between the card type. The database is then updated with the additional information from the card such that future transactions will be recognized as being debit capable.

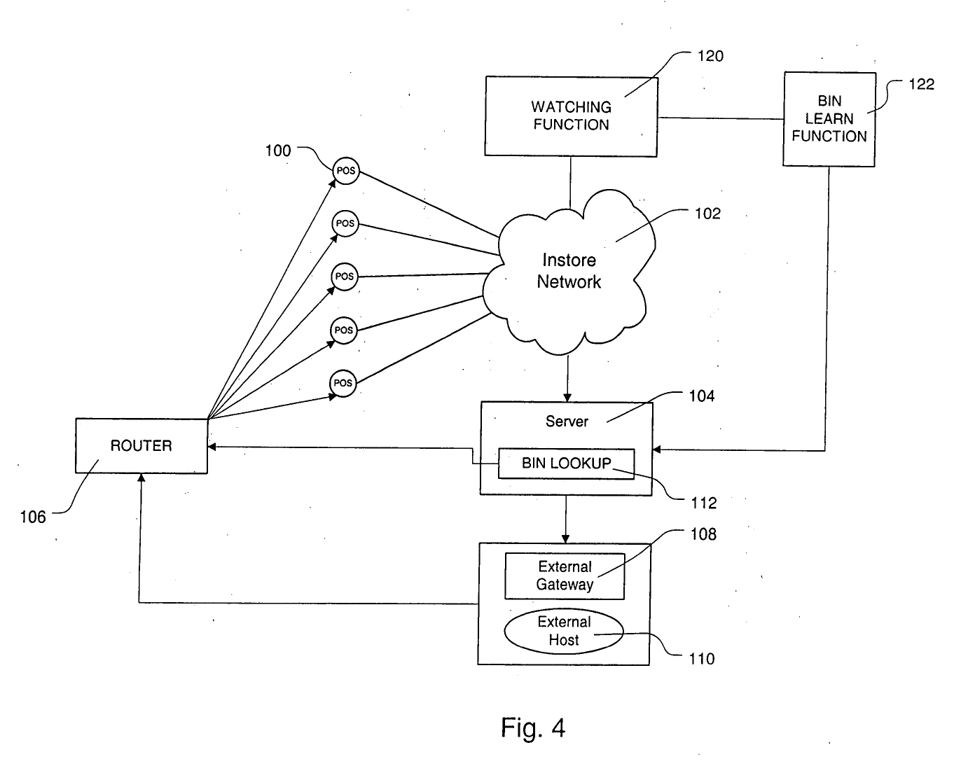

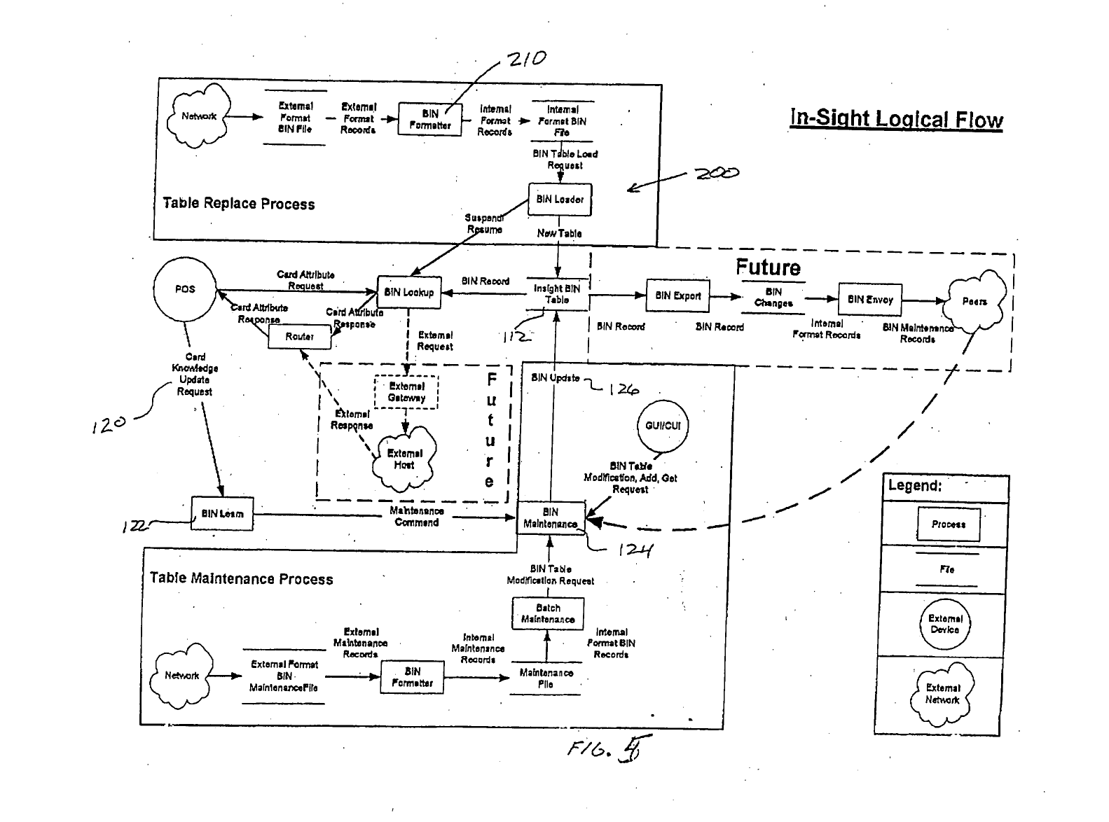

FIG. 4 shows a single retail outlet having multi lanes indicated by the point of sale (POS) terminals 100. In this case, five terminals are shown connected to an in store network 102 and the server computer 104. The server computer 104 includes the database of BIN tables which preferrably have been reformatted in a standard manner to combine BIN tables from various institutions. In most cases, these BIN tables allow recognition of cards which are credit cards, debit only cards or cards which are unknown to be debit capable. These unknown cards could be cards which are indeed debit cards but which have been issued by an institution associated with VISA or MASTERCARD, for example. These issuing institutions have not made it immediately determinable whether the card has debit capability. The database of BIN tables allows recognition of known debit cards.

Each terminal upon a customer determining that payment will be made by a financial transaction card, swipes the card at the point of sale terminal and the information from the card is typically derived from the mag stripe. It is also possible that this information can be obtained in other ways. The swiped information includes the particular identity of the card and transaction routing information. Part of the serial number of the card includes the primary account number. At least this portion of the information is forwarded to the in store computer database server 104. A signal is sent back to the point of sale terminals 100 through the router 106. If the primary account number identifies the account as being debit capable, the point of sale terminal 100 will prompt the customer to enter a PIN. If the BIN table look up has failed to identify the card as debit capable and recognized it to be purely credit capable, a different signal will be sent to the point of sale terminal 100 allowing the processing based on a credit protocol.

The third possibility is that the BIN table database has failed to determine whether it is debit capable or credit capable and there is the possibility that it may be debit capable. In this case, a further signal is sent to the point of sale terminal causing the point of sale terminal to display a prompt that will force the customer to provide an indication whether he wishes the transaction settled as a debit or a credit transaction. In the case that the customer decides on a debit transaction, he is then prompted to enter a PIN. This modified debit transaction does allow the customer to default to a signature based debit transaction but only after he has been initially prompted to complete based on a PIN transaction.

With this arrangement, the cards which are recognized as being debit capable, are initially processed as PIN based transactions and only defaulted to signature based transactions by the customer refusing to enter the PIN. Cards which are unknown to be debit capable, are processed in a manner to allow the customer to enter a debit option or a credit option. Preferrably, the system watches for a debit indication by the customer and updates the database such that future transactions will recognize the card as being debit capable.

The in store database server 104 is able to provide a fast pre evaluation of the card in that outside telecommunications are not involved. This evaluation typically occurs in a few seconds and preferrably, less than five seconds. The system allows the customer to swipe the card initially, typically before the financial transaction is complete, i.e., as the clerk is still processing the various items to be purchased. The customer is prompted to swipe his card and the information is provided to the onsite database for the pre evaluation. In this way, no additional delays are incurred and the pre evaluation step merely uses the time needed by the clerk to enter the various items. Once the clerk is ready to tender the sale, the transaction amounts can be completed.

From the above, it can be appreciated that the system completes an onsite or in store evaluation of the financial transaction card. This provides rapid feedback and provides higher reliability in that outside communications are not necessary for the pre evaluation.

If the customer indicates he wishes to proceed as a debit transaction, the system monitors this transaction using the watching function 120 and if the transaction is successfully completed, the system records the information of the card at the BIN learn function 122 and this information will be used to modify the BIN lookup table 112. Thus, the system is watching transactions and in the case of transactions where the debit payment has been successfully completed, for a previously unknown card, the card is added to the database as debit capable.

In the arrangement of FIG. 5, the card information is sent to a BIN maintenance function 124 and from time to time, a BIN update process 126 is carried out to modify the onsite BIN table 112. This watching capability 120 allows a single retail site to update its own records based on transactions that occur onsite. This process can be carried out over a complete chain of stores where the BIN maintenance function 124 is a collective group function of all information that has been learned from all stores. The onsite BIN table 112 is updated from time to time and this updated table is provided to each site as a BIN lookup table. Updates can be merely added to the table or the complete table can be replaced.

From time to time, information from different institutions will be received and can be reformatted as generally shown in the arrangement 200. The BIN file requires reformatting which is carried out at 210 into the desired internal formal, then this information can be added to the insite BIN table 112. The process of updating the BIN table has been described with respect to a particular store as well as to a particular chain of stores and provides improvements to the BIN table 112 based on watching of the actual transactions as well as entering additional information, as provided by the institutions.

In addition, the watching capability of the system can allow watching for debit transactions, and if this occurs with a previously unknown card, the system can provide a code for future transactions to initially prompt the user to pay for the transaction as a PIN based debit transaction.

The BIN table 112 shown in FIG. 5 is representative of the continually improving BIN table of a particular chain. In some cases, it may be desirable for different chains to share information therebetween. For example, a large retail clothing chain may determine that it is practical to additionally share information with a large home improvement chain as they do not particularly compete, and it is desirable for both of them to have the most current and complete BIN table. In this way, a further improved BIN table can be derived which is provided to each of the cooperating parties. This sharing of information can be administrated by yet a third party who does the reformatting of the BIN tables based on the information provided by both of the chains and continues to update both tables from time to time.

In yet a further aspect of the invention, the party that administers the system may make the improved tables available to smaller retailers on a cost or fee basis. This allows a large retail outlet to derive additional revenue from their learned information. Over time, the pooling of information based on the customer's actual transactions will result in a BIN table which is accurate and is particularly effective in recognizing cards which are debit capable.

In a further aspect of the invention, it is the provision of the BIN table to additionally record when the card information was modified and by what party. In this way, records can be tracked.

The BIN table also allows for recognizing different paths which debit transactions will follow. For example, there may be three different processing paths for different providers and the system recognizes that certain cards are capable of more than one path. The system records cost information with respect to paths for that merchant. For example, a large chain may have negotiated a favourable rate with a particular path, and as such, it is the preferred or most cost effective path. The system will provide to the point of sale terminal, directions with respect to the preferred path, and thus the system is capable of routing the transaction in a cost efficient manner. This can also be carried out for signature based debit transactions.

With the present system, the merchants are tracking their own transactions and reports can be generated with respect to debit transactions, the number of debit transactions that were PIN based, and the number of debit possible transactions where the customer defaulted to signature based debit transactions. This is valuable information to the merchant and may assist the merchant in designing incentives to encourage the customer to process transactions using the PIN based debit protocol. Although there is no immediate benefit to the customer, the customer can be educated to recognize that there is a transaction cost associated with each purchase and it is ultimately in his benefit to have it processed efficiently.

The present system and method provides an effective automated system for providing in real time, an effective option for recognizing debit capable financial transaction cards as well as a system for encouraging or promoting payment as a PIN based debit transaction. The prior art approaches of relying on sales clerks or other staff to encourage the customer to complete the transaction as a PIN based debit transaction have not proven effective.

In contrast, the present system conducts a pre evaluation and appropriately processes the transaction to encourage a PIN based transaction if it is possible. The system also watches successful debit transactions which were not initially identified and adds this information to the system for future use. The system does not merely default to debit transactions as this can result in significant customer complaints and dissatisfaction. The system is capable of conducting the pre evaluation quickly whereby multi lane environments continue to be time efficient.

The present system over time will also reduce the importance and the control the institutions have with respect to financial transaction cards. Basically the watching function which is carried out instore by the store provides information with respect to how the transaction was successfully completed. This allows the store to develop its own database and reduces the reliance that the merchant has with respect to the various financial institutions. The system provides for tracking of transactions which have been converted and the savings which have been realized. Various incentives can be used to encourage customers to complete transactions using a PIN based debit protocol.

The watching function of the present invention on its own without preloaded BIN tables can eventually provide a valuable database merely by adding card information where the transaction was successfully completed as a PIN based debit transaction.

Although various preferred embodiments of the present invention have been described herein in detail, it will be appreciated by those skilled in the art, that variations may be made thereto without departing from the spirit of the invention or the scope of the appended claims.

What is claimed is:

1. An arrangement for identifying and processing transactions that may be capable of being settled using a debit protocol, said system comprising:
an onsite store computer system connected through an outside network to a financial transaction network;
said store computer system including a series of terminals for the electronic payment of purchases, an onsite database computer connected to each terminal and communicating therewith;
each terminal including a device for receiving a financial transaction card and determining a primary account number associated therewith,
means for communicating said primary account number to said onsite database computer;
said onsite database computer, upon receiving a primary account number from any of said terminals, evaluating said primary account number and providing a report to the respective terminal whether the primary account number is recognized by the onsite database computer as debit transaction capable;
each terminal upon receipt of a report indicating that the primary account number is known to be debit transaction capable, producing a prompt for the cardholder to enter a PIN authorization and, upon receipt of a PIN, processing the transaction using a PIN based debit protocol,
said terminal upon receipt of a signal indicating PIN authorization will not be completed by the cardholder, providing other alternatives for completing authorization of the transaction.

2. An arrangement as in claim 1 wherein:
upon successful completion of a financial transaction using a debit protocol of a particular financial transaction card where the onsite database computer did not provide a report indicating the primary account number is known to be debit capable, updating the database such that in processing future transactions this primary account number will be recognized as debit capable.

3. An arrangement as in claim 2 wherein:
each terminal, upon failure to receive a report from said onsite database within a specified time period of communicating said primary account number, assumes a protocol prompting the user to provide an indication of payment type as debit or credit.

4. An arrangement as in claim 3 wherein said specified time period is less than 5 seconds.

5. An arrangement as in claim 4 including at least five terminals.

6. An arrangement as in claim 2 wherein:
said onsite database computer communicates with a central database computer at a remote location and each onsite database computer receives updates from said central database computer of primary account numbers which have become recognized as debit capable.

7. An arrangement for identifying and processing transactions that are capable of being settled using a debit protocol, said system comprising:
a plurality of onsite store computer systems connected through an outside network to a remote computer system which is in communication with each store computer system;
each store computer system including a series of terminals for the electronic payment of purchases which terminals cooperate with an onsite database computer;
each terminal including a device for receiving a financial transaction card and determining a primary account number associated therewith,
means for communicating said primary account number to said onsite database computer;
said onsite database computer, upon receiving a primary account number from any of said terminals, evaluating said primary account number and providing a report to the respective terminal whether the primary account number is recognized by the onsite database computer as debit transaction capable;
each terminal upon receipt of a signal indicating debit transaction capable producing a prompt for the cardholder to enter a PIN authorization and, upon receipt of a PIN, processing the transaction using a debit protocol,
said terminal, upon an indication PIN authorization will not be completed by the cardholder, providing other alternatives for completing authorization of the transaction.
